(19) United States
(12) Patent Application Publication
(10) Pub. No.: US 2025/0346105 A1
(43) Pub. Date: Nov. 13, 2025

(54) Underbody Protection Device, Housing Lower Part, Vehicle Floor Device, and Motor Vehicle

(71) Applicant: Bayerische Motoren Werke Aktiengesellschaft, Muenchen (DE)

(72) Inventors: Andreas HUBER, Schoenberg (DE); Rene TREFFLER, Dasing (DE)

(21) Appl. No.: 18/871,182

(22) PCT Filed: Jun. 30, 2023
(86) PCT No.: PCT/EP2023/067948

§ 371 Date: Dec. 3, 2024

(30) Foreign Application Priority Data
Jul. 20, 2022 (DE) 10 2022 118 134.0

(51) Int. Cl. B60K 1/04; B62D 25/20; H01M 50/227; H01M 50/249

(52) U.S. Cl. CPC B60K 1/04; B62D 25/20; H01M 50/227; H01M 50/249; B60K 2001/0438; H01M 2220/20

(57) ABSTRACT

Please substitute the new Abstract submitted herewith for the original Abstract; An apparatus for an electrically drivable motor vehicle includes an underbody protection device. The underbody protection device is configured to be reversibly secured to a battery housing of a traction battery of the electrically drivable motor vehicle and that covers at least some regions of the battery housing toward a bottom of a vehicle vertical direction in an installed position. The underbody protection device has a first underbody element and a second underbody element, between which a spacer is arranged, such that the underbody elements form a sandwich structure with the spacer.

### SPECIFICATION

Submitted herewith is a substitute specification and marked-up version thereof. The substitute specification contains no new matter and includes the changes indicated in the marked-up copy of the original specification.

### BACKGROUND AND SUMMARY

The disclosure relates to an underbody protection device for an electrically drivable motor vehicle, a housing lower part for a battery housing of a traction battery of an electrically drivable motor vehicle, a vehicle floor device for an electrically drivable motor vehicle and a motor vehicle.

The underbody of a motor vehicle in many high-voltage storage systems is part of a high-voltage storage system housing and cannot be changed in the event of damage. In a storage system architecture made of interconnected cell modules, which is designated as a so-called cell-to-module storage system architecture, a housing lower part of the housing is generally reinforced by supporting structures for the cell modules, as a result of which underbody protection against intrusion, for example by bollards, is assisted. In what is known as the cell-to-pack storage system architecture, the housing part is largely designed without additional reinforcement, as a result of which underbody protection is more difficult to satisfy. In addition to the danger of intrusion, there is the danger of corrosion, in particular in steel components, even with relatively small levels of damage or scratches. In the event of damage to a high-voltage storage system housing lower part, this cannot be changed or changed only with difficulty. In the worst case, the entire high-voltage storage system must be replaced.

WO 2018/029168 A1 discloses a battery box for receiving one or more battery elements, having a box profile forming an internal region which, at least partly, provides outer side walls of the battery box, having a cover, having a floor and having attachment profile for the attachment of the battery box to the motor vehicle. An underbody protector is provided underneath the floor. The underbody protector is substantially plate-like and extends horizontally in an installed position of the battery box. This underbody protector is screwed to the box profile.

It is an object of the present disclosure to devise a solution which permits particularly good protection of an underbody of a motor vehicle against damage, a traction battery being arranged in an underbody region of the motor vehicle.

This object is achieved by the subject-matters of the disclosure. Further possible embodiments of the disclosure are disclosed in the the description and the figures, Features, advantages and possible embodiments which, within the context of the description, are set out for one of the subject-matters of the independent claims are to be viewed at least analogously as features, advantages and possible embodiments of the respective subject-matter of the other independent claims and any possible combination of the subject-matters of the independent claims, if appropriate in conjunction with one or more of the sub-claims.

The disclosure relates to an underbody protection device for an electrically drivable motor vehicle. The underbody protection device is configured to be reversibly secured to a battery housing of a traction battery of the motor vehicle. For this purpose, the underbody protection device can be screwed and/or adhesively bonded to the battery housing. The traction battery is configured to provide electrical energy for an electric drivetrain of the motor vehicle, by which means the motor vehicle can be driven electrically with electrical energy from the traction battery. The battery housing encloses a storage volume, in which a large number of battery cells of the traction battery can be accommodated. The reversible securing of the underbody protection device to the battery housing is to be understood such that the underbody protection device can be separated from the battery housing, as a result of which the underbody protection device can be replaced. The underbody protection device is configured to cover at least some regions of the battery housing toward the bottom in the vehicle vertical direction in the intended installed position. The underbody protection device thus protects the battery housing against mechanical actions from below when installed, as a result of which the battery cells of the traction battery can be protected against damage.

The underbody protection device comprises a first underbody element and a second underbody element, between which a spacer is arranged, as a result of which the underbody elements form a sandwich structure with the spacer. In other words, the first underbody element and the second underbody element delimit an intermediate space between them, which is a closed hollow space. The first underbody element can delimit this intermediate space toward the top in the vehicle vertical direction, whereas the second underbody element delimits this intermediate space toward the bottom in the vehicle vertical direction. The intermediate space can in particular be delimited completely by the underbody elements. In order to permit particularly good protection of the battery cells of the traction battery, the two underbody elements cover all the battery cells toward the bottom in the vehicle vertical direction.

The spacer, which is configured to maintain a minimum distance between the underbody elements, is arranged in the intermediate space. The spacer can be formed, for example, by a spacer foam. The spacer can be formed completely or partly of plastic. In particular the spacer is configured to be porous or has a hollow stricture or a honeycomb structure. The underbody protection device thus has the sandwich structure comprising the first underbody element, the spacer and the second underbody element in this order along the vehicle vertical direction. As a result of the arrangement of the first underbody element and of the second underbody element spaced apart relative to each other by means of the spacer, a particularly high Steiner component can be achieved, as a result of which, in turn, the underbody protection device has a particularly high stability. For the area moment of inertia, the product of the cross-sectional area and the square of the distance of the surface center of gravity from the axis of rotation is designated the Steiner component.

Because the underbody protection device can be reversibly secured to the battery housing, the underbody protection device can be replaced particularly simply and quickly, for example in the event of dam age to the underbody protection device. Replacement of the entire underbody of the motor vehicle, including the traction battery, in the event of damage to the underbody protection device is thus not necessary. As a result of the sandwich structure, the underbody protection device has a particularly high stability, as a result of which, in turn, the battery housing can be protected particularly well against damage.

In a possible development of the disclosure, provision is made for the underbody elements to comprise a fiber-reinforced plastic (FRP). In particular, at least one of the underbody elements can be formed as a metal-FRP hybrid. The plastic can in particular be reinforced with glass fibers and/or with carbon fibers. For example, the plastic is reinforced with unidirectional fibers. In particular, it is a glass endless-fiber-reinforced plastic. The respective underbody elements can be produced in the wet pressing method, in which a glass-fiber textile is impregnated with liquid resin, then shaped and cured. The underbody elements can be produced separately from one another and stacked on one another with the spacer to form the sandwich structure. The production of the underbody elements from the fiber-reinforced plastic permits particularly good protection of the battery housing against damage with, at the same time, a particularly low weight of the underbody protection device.

The disclosure further relates to a housing lower part for the battery housing of the traction battery of the electrically drivable motor vehicle. The housing lower part is configured to delimit a storage volume for a large number of battery cells of the traction battery. The housing lower part delimits the storage volume toward the bottom in the vehicle vertical direction in the intended installed position. The housing lower part has a storage area, on which the battery cells can be accommodated. In this storage area, the housing lower part has at least one predetermined break point which, when it fails, forms an opening in the housing lower part Via this opening, gas emerging from a battery cell can be transported away from the storage volume. This gas can nr particular be liberated during a so-called thermal runaway of the battery cell. In order to avoid damage to further battery cells of the traction battery as a result of propagation during the thermal runaway of this battery cell, the gas is thus transported away from the storage volume Nia the opening formed by the failure of the at least one predetermined break point. The danger of propagation and thus of thermal runaway of further battery cells because of a development of heat can be kept particularly low hereby. The predetermined break point of the housing lower part is configured to fail in the event of thermal runaway of at least one of the battery cells. In this way, gas produced during the thermal runaway of the battery cell can reliably be transported away from the storage volume via the opening produced in the housing lower part, and thus a high temperature rise in the storage volume can be avoided. In this way, particularly good protection of the traction battery against the propagation of fire over a plurality of battery cells is created.

In a possible development of the disclosure, provision is made for the housing lower part to have a separate predetermined break point for each battery cell, wherein each predetermined break point is arranged underneath the respectively associated battery cell in the vehicle vertical direction in the intended installed position. For example, the battery cells can be round cells with a vent opening directed downward in the installed position. As a result of providing a respective predetermined break point for each of the battery cells, it is made possible for gas produced during thermal runaway of a battery cell to be transported away on a short path via the opening produced by the failure of the associated predetermined break point, and thus particularly quickly out of the storage volume. In this way, reliable transport of gas away from the storage volume in the event of thermal runaway of the battery cell is ensured.

The disclosure also relates to a vehicle floor device for an electrically drivable motor vehicle having a battery housing for a traction battery, wherein the battery housing has a housing lower part, as has been described already in connection with the housing lower part according to the disclosure. Alternatively or additionally, an underbody protection device is reversibly secured to the battery housing and covers at least some regions of the battery housing toward the bottom in the vehicle vertical direction in the intended installed position. This underbody protection device can correspond to the underbody protection device described in connection with the underbody protection device according to the disclosure. Alternatively, the underbody protection device can be formed monolithically and thus in one piece. The battery housing and the underbody protection device seal off an internal space of the battery housing tightly. The reversible securing of the underbody protection device to the battery housing is to be understood such that the underbody protection device can be removed from the battery housing, as a result of which, for example in the event of damage to the underbody protection device, the underbody protection device on the battery housing can be replaced. Non-destructive removal or removal with the destruction of at least one of the components can be envisaged. In particular, the vehicle floor device can comprise both the housing lower part according to the disclosure and the underbody protection device according to the disclosure, as a result of which the housing lower part is particularly well protected against damage by means of the underbody protection device. This makes it possible for the housing lower part to be made particularly thin and thus have a particularly low weight and/or be made from a plastic. The housing lower part permits further battery cells to be particularly well protected against damage in the event of thermal runaway of one battery cell, in that the gases produced during the thermal runaway of the battery cell can be led away from the storage volume via the opening which results from the failure of the at least one predetermined break point.

In a possible development of the disclosure, provision is made for the vehicle floor device to comprise both the housing lower part and the underbody protection device, and for the housing lower part and the underbody protection device together to delimit a degassing chamber, into which the gas flows via the opening and via which the gas can be transported away from the storage volume. The degassing chamber makes it possible for the gas to be transported particularly quickly out of the storage volume, to be collected in the degassing chamber and, collected via the degassing chamber, to be led out of the vehicle underbody device. The degassing chamber extends between the housing lower pail and the underbody protection device. In particular, the degassing chamber covers all the battery cells of the traction battery toward the bottom in the vehicle vertical direction. In this way, it is ensured that gases arising from each of the battery cells during their thermal runaway can be transported away on a particularly short path via the opening produced by the failure of the associated predetermined break point. In this way, collecting the gases produced in the storage volume can be at least substantially avoided.

In a possible development of the disclosure, provision is made for an impact absorption structure to be arranged in the degassing chamber. This impact absorption structure is what is known as a crash absorber structure. This impact absorption structure is configured to be deformed during mechanical action on the underbody protection device, as a result of which damage to the housing lower part and the battery cells can be counteracted. This impact absorption structure can, for example, comprise a foam. The impact absorption structure can rest with a first side on the underbody protection device and with a second side opposite to the first side on the housing lower part, as a result of which the underbody protection device is supported against the housing lower part via the impact absorption structure. This can ensure that a minimum distance between the underbody protection device and the housing lower part is maintained. In particular, provision is made for the impact absorption structure to cover all the battery cells of the traction battery toward the bottom in the vehicle vertical direction in the intended installed position, as a result of which the battery cells can be protected particularly well by means of the impact absorption structure against damage as a result of mechanical action.

In a further possible embodiment of the disclosure, provision is made for the impact absorption structure to have at least one gas conduction duct, which is configured to lead the gas away from the battery cells. The at least one gas conduction duct can in particular extend starting from the opening produced during the failure of the at least one predetermined break point, in order to be able to lead gas flowing into the degassing chamber via the opening particularly quickly and reliably away from the opening. The at least one gas conduction duct thus permits particularly reliable and targeted guidance of gas in the degassing chamber, wherein, at the same time, the housing lower part and the battery cells can be protected particularly well by means of the impact absorption structure against damage. The impact absorption structure can, for example, have a separate gas conduction duct for each predetermined break point. Alternatively, the impact absorption structure can have a common gas conduction duct for a plurality of predetermined break points, via which gas flowing into the degassing chamber via a plurality of openings can be collectively transported. In this way, overheating of further battery cells arranged beside the battery cell running away thermally can be curtailed.

In a farther possible embodiment of the disclosure, provision is made for the underbody protection device to be secured to the housing lower part via at least one screw connection. The at least one screw connection permits particularly simple securing of the underbody protection device to the battery housing and detachment of the underbody protection device from the battery housing, as a result of which the underbody protection device can be replaced particularly simply. At the same time, the at least one screw connection permits particularly secure retention of the underbody protection device on the housing lower part.

The disclosure also relates to a motor vehicle having a, vehicle floor device as has already been described in connection with the vehicle floor device according to the disclosure. The vehicle floor device is arranged in a floor area of the motor vehicle. The vehicle floor device can form at least some regions of an underbody of the motor vehicle. The motor vehicle is in particular a motor car, in particular a passenger car. The motor vehicle is designed to be driven by means of electrical energy from a traction battery. This means that the motor vehicle is a hybrid vehicle or an electric vehicle.

Further features of the disclosure can be gathered from the claims, the figures and the figure description. The features and feature combinations mentioned above in the description and the features and feature combinations shown below in the figure description and/or on their own in the figures can be used not only in the respectively specified combination but also in other combinations or on their own without departing from the scope of the disclosure.

In the drawings:

### BRIEF DESCRIPTION OF THE DRAWINGS

FIG. 1 shows a schematic sectional view of a region of a vehicle floor device, having a battery housing which has a housing lower part, and having an underbody protection device reversibly secured to the housing lower part;

FIG. 2 shows a schematic sectional view of a region of the vehicle floor device; and

FIG. 3 shows a sectional view of a region of the underbody protection device, on which an impact absorption structure is arranged.

### DETAILED DESCRIPTION OF THE DRAWINGS

In the figures, identical and functionally identical elements are provided with the same designations.

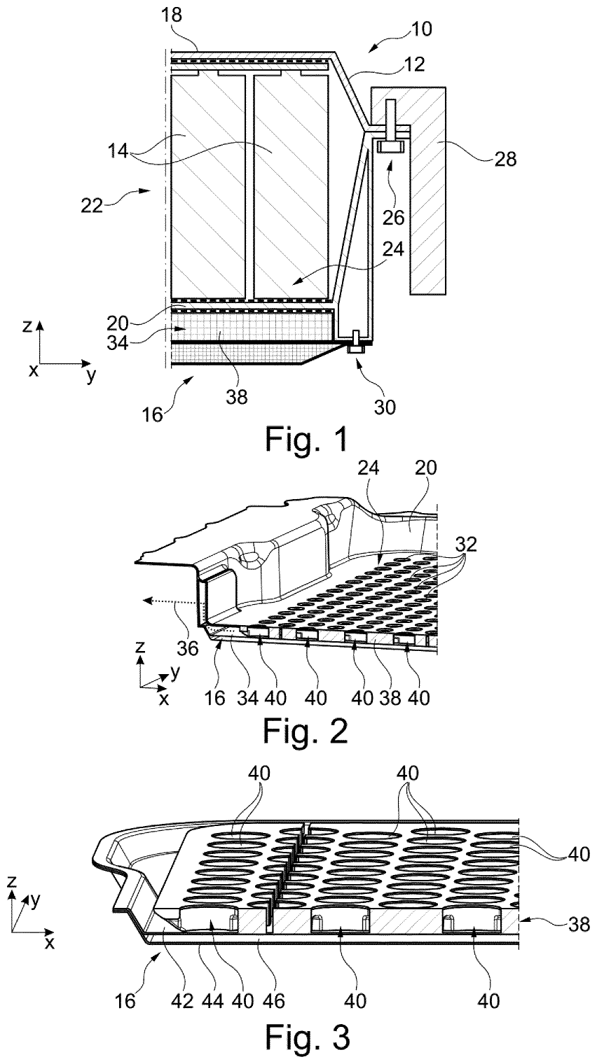

A vehicle floor device 10 for an electrically drivable motor vehicle is shown in FIG. 1 as a detail and in section. The vehicle floor device 10 is designed to be arranged hi a floor area of the motor vehicle. The motor vehicle comprises an electric drivetrain, via which the motor vehicle can be driven by means of electrical energy from a traction battery of the motor vehicle. The traction battery comprises a large number of battery cells 14 accommodated in a battery housing 12. In the present case, the battery cells 14 are respective round cells. The battery cells 14 in the present case are lithium ion cells. The battery cells 14 are designed to store electrical energy and to provide the electrical energy for the electric drivetrain of the motor vehicle.

The vehicle floor device 10 comprises the battery housing 12 of the traction battery and an underbody protection device 16 reversibly secured to the battery housing 12. In the present case, the battery housing 12 comprises a housing upper part 18 and a housing lower part 20 which together delimit a storage volume 22. The housing upper part 18 delimits the storage volume 22 toward the top in the vehicle vertical direction z, and the housing lower part 20 toward the bottom in the vehicle vertical direction z in the intended installed position of the vehicle floor device 10. All the battery cells 14 of the traction battery can be accommodated in the storage volume 22. The housing lower part 20 has a storage area 24, on which the battery cells 14 can be accommodated. This means that in the traction battery, the battery cells 14 are placed on the housing lower part 20 in the storage area 24. In addition, the housing upper part 18 and the housing lower part 20 are secured to each other via at least one first screw connection 26. Via this first screw connection 26, the housing upper part 18 and the housing lower part 20 are additionally secured to a sill 28 of the motor vehicle.

The underbody protection device 16 is secured to the housing lower part 20 via at least one second screw connection 30. The underbody protection device 16 is designed to protect the housing lower part 20 and the battery cells 14 against damage from below, for example as a result of mechanical action. As a result of the reversible securing of the underbody protection device 16 to the housing lower part 20 via the at least one second screw connection 30, the underbody protection device 16 can be removed from the housing lower part 20 and replaced by a further underbody protection device. Thus, replacement of the underbody protection device 16, for example in the event of damage to the underbody protection device 16, is particularly simply possible.

In the present case, the housing lower part 20 is designed in the form of a high-voltage storage trough and is shown in detail in FIG. 2. In FIG. 2, the housing lower part 20 is shown as a detail and in section. In the present case, the housing lower part 20 is produced from a plastic, in particular a long-fiber thermoplastic and/or a lightweight structural plastic. Alternatively, the housing lower part 20 can be produced from a metal or a metal alloy.

As can be seen particularly well in FIG. 2, the housing lower part 20 in the storage area 24 has a plurality of predetermined break points 32, of which, for reasons of clarity, only some are identified by a designation in the figures. In the present case, a respective predetermined break point 32 is provided for each battery cell 14 which, in the intended installed position of the vehicle floor device 10, is arranged underneath the respective associated battery cell 14 in the vehicle vertical direction z. In the present case, the respective predetermined break points 32 are of rounded design but any other shape is likewise conceivable. The predetermined break points 32 are designed to fail the event of thermal runaway of the respective associated battery cell 14. During the failure of the respective predetermined break point 32, an opening is formed in the housing lower part 20. This means that, during the thermal runaway of the battery cell 14, the predetermined break point 32 associated with this battery cell 14 fails, as a result of which the opening is formed at the predetermined break point 32. If a plurality of predetermined break points 32 fail, then a respective opening in the housing lower part 20 can be formed by each of the predetermined break points 32. Via these openings that are formed, the gas 36 produced during the thermal runaway of the battery cell 14 can be led away out of the storage volume 22. In the present case, the gas 36 is led via the at least one opening formed into a degassing chamber 34 arranged between the housing lower part 20 and the underbody protection device 16, via which chamber the gas 36 is led out of the vehicle floor device 10.

In the present case, an impact absorption structure 38 is arranged in the degassing chamber 34. This impact absorption structure 38 is used firstly to absorb energy as a result of deformation in the event of mechanical action, for example an impact, on the underbody protection device 16 and, secondly, to support the underbody protection device 16 against the housing lower part 20. In the present case the impact absorption structure 38 is provided by a crash absorber foam. In order to ensure reliable conduction of the gases 36 into the degassing chamber 34, in the present case the impact absorption structure 38 has a plurality of gas conduction ducts 40, which are designed to guide the gas 36 flowing into the degassing chamber 34 via the openings. In the present case, a gas conduction duct 40 is provided for each predetermined break point 32, wherein a respective inlet opening of the gas conduction duct 40 is arranged to adjoin the associated predetermined break point 32 in order to ensure reliable conduction of the gas 36 flowing into the degassing chamber 34 via the respective opening as the openings are formed. The impact absorption structure 38 permits the integration of gas conduction ducts 40 into the vehicle floor device 10, as a result of which, in the event of a thermal event of the battery cells 14, gas 36 can be particularly easily transported away from the battery cells 14.

If one of the battery cells 14 explodes, then the housing lower part 20 breaks open at the associated predetermined break point 32, via which, via the opening which results, gas 36 produced during the explosion of the battery cell 14 can be transported away into the degassing chamber 34. The degassing chamber 34 is formed by an intermediate space between the housing lower part 20 and the underbody protection device 16. The fact that the housing lower part 20 is covered toward the bottom by the underbody protection device 16 in the vehicle vertical direction z means that there are only particularly low strength requirements on the housing lower part 20. In the present case, the respective predetermined break points 32 are formed by locally particularly thin areas of the housing lower part 20. The housing lower part 20 and thus the battery housing 12 can thus be produced with a particularly low weight.

In FIG. 3, the underbody protection device 16 is shown as a detail and in section, wherein the impact absorption structure 38 having the gas conduction ducts 40 is arranged on the underbody protection device 16. The underbody protection device 16 has a sandwich structure comprising a first, upper underbody element 42, a second, lower underbody element 44 and a spacer 46 arranged between the underbody elements 42, 44. In the present case, the spacer 46 is formed from a foam. Thus, the underbody protection device 16 has a foam core. Both the first underbody element 42 and the second underbody element 44 are each produced from a glass fiber-reinforced plastic. As can be seen particularly well in FIG. 3, the underbody elements 42, 44 are designed as flat plates in an entire area in which the underbody elements 42, 44 cover the impact absorption structure 38 toward the bottom in the vehicle vertical direction z. These flat plate-like areas of the underbody elements 42, 44 are arranged parallel to one another and above one another in the vehicle vertical direction z. In this way, particularly high stability of the underbody protection device 16 can be achieved. This makes it possible for an impact on the underbody protection device 16 to be absorbed particularly well, as a result of which, in turn, the housing lower part 20 can be protected particularly well against damage. The underbody protection device 16 is thus an underbody protection component for the battery housing 12 which can be particularly simply replaced in the event of damage. In the present case, the underbody protection device 16 is a glass-fiber component reinforced with unidirectional fibers in a sandwich structure having the foam core.

Overall, the disclosure relates to underbody protection for a high-voltage storage system housing.

### LIST OF DESIGNATIONS

10 Vehicle floor device
12 Battery housing
14 Battery cell
16 Underbody protection device
18 Housing upper part
20 Housing lower part
22 Storage volume
24 Storage area
26 First screw connection
28 Sill
30 Second screw connection
32 Predetermined break point
34 Degassing chamber
36 Gas
38 Impact absorption structure
40 Gas conduction duct
42 First underbody element
44 Second underbody element
46 Spacer
z Vehicle vertical direction

1.-10. (canceled)

11. An apparatus for an electrically drivable motor vehicle, comprising:
an underbody protection device that is configured to be reversibly Secured to a battery housing of a traction battery of the electrically drivable motor vehicle and that covers at least some regions of the battery housing toward a bottom of a vehicle vertical direction (z) in an installed position, wherein
the underbody protection device has a first underbody element and a second underbody element, between which a spacer is arranged, such that the underbody elements form a sandwich structure with the spacer.

12. The apparatus according to claim 11, wherein the underbody elements comprise a fiber-reinforced plastic.

13. A housing apparatus comprising:
a housing lower part associated with a battery housing of a traction battery of an electrically drivable motor vehicle, which is designed to delimit a storage volume for a number of battery cells of the traction battery, wherein
the housing lower part has a storage area, on which the number of battery cells are accommodatable, and
in the storage area, the housing lower part has at least one predetermined break point which, upon failure, forms an opening in the housing lower part, via which gas emerging from the number of battery cells is transported away from the storage volume.

14. The housing apparatus according to claim 13, wherein the housing lower part has a separate predetermined break point for each of the number of battery cells, and each predetermined break point is arranged underneath a respectively associated battery cell in the vehicle vertical direction (z) in the installed position.

15. A vehicle floor device for an electrically drivable motor vehicle, comprising: a battery housing for a tr-action battery, wherein the battery housing has the housing lower part according to claim 13.

16. The vehicle floor device according to claim 15, further comprising
an underbody protection device that is configured to be reversibly secured to a battery housing of a traction battery of the electrically drivable motor vehicle and that covers at least some regions of the battery housing toward a bottom of a vehicle vertical direction (z) in an installed position, wherein
the underbody protection device has a first underbody element and a second underbody element, between which a spacer is arranged, such that the underbody elements form a sandwich structure with the spacer.

17. The vehicle floor device according to claim 16, wherein the underbody protection device covers at least sore regions of the battery housing toward the bottom in the vehicle vertical direction (z) in the installed position.

18. The vehicle floor device according to claim 15, wherein
the housing lower part and the underbody protection device together delimit a degassing chamber, into which the gas flows via the opening and via which the gas is be transported away from the storage volume.

19. The vehicle floor device according to claim 18, further comprising:
an impact absorption structure that is arranged in the degassing chamber.

20. The vehicle floor device according to claim 19, wherein
the impact absorption structure has at least one gas conduction duct, which is configured to lead the gas away from the battery cells.

21. The vehicle floor device according to claim 15, wherein
the underbody protection device is secured to the housing lower part via at least one screw connection.

22. A motor vehicle having a vehicle floor device according to claim 15.
